(19) United States
(12) Patent Application Publication
(10) Pub. No.: US 2017/0056846 A1
(43) Pub. Date: Mar. 2, 2017

(54) STATIC MIXER

(71) Applicant: Dow Global Technologies LLC, Midland, MI (US)

(72) Inventors: Zhao Yu, Midland, MI (US); Michael D. Cloeter, Lake Jackson, TX (US); Joy L. Mendoza, Seabrook, TX (US); Philippe P. Maillot, Kingwood, TX (US); Stacy W. Hoy, IV, Houston, TX (US)

(21) Appl. No.: 15/308,293

(22) PCT Filed: May 8, 2015
(86) PCT No.: PCT/US2015/029848

§ 371 Date: Nov. 1, 2016

Related U.S. Application Data
(60) Provisional application No. 61/990,965, filed on May 9, 2014.

(51) Int. Cl. B01F 5/06

(52) U.S. Cl. CPC B01F 5/0688; B01F 5/0608

(57) ABSTRACT

A static mixer (10) for combining a first fluid and a second fluid. The static mixer (10) including a plurality of plates (18, 24, 32, 40) having orifices (20, 26, 28) formed therethrough. As the first fluid and the second fluid pass through the static mixer (10), the fluids are combined and mixed.

### FIELD

This disclosure relates generally to a static mixer that is suitable for use in combining two or more fluids.

### BACKGROUND

It is often desired to mix a first fluid with a second fluid. In many processes, the first fluid and the second fluid will be separately piped to a T-junction where both fluids will then pass together through an in-line static mixer. Some known static mixers include a series of spaced plates having orifices formed through each plate. As the first and second fluids pass through the plates, the fluids intermix. The shape of the orifices formed through each plate determines both the extent of mixing and the pressure drop across the mixer.

The extent of mixing is commonly described using the coefficient of variation (COV). COV is defined as the standard deviation of concentration as measured within a cross-section, within a defined volume, or time-averaged at a point, divided by the mean concentration. A COV value of zero corresponds to a perfectly mixed system. A COV of 0.05 is considered as having “good” mixing. A COV of 0.02 is considered as having “very good” mixing. Pressure drop is measured as the drop in pressure across the various plates which define the static mixer.

For some systems, the first fluid and the second fluid have properties such that the static mixer must be formed from corrosion-resistant materials. Such materials are typically more expensive.

An improved in-line static mixer is desired which provides good or very good mixing with low pressure drop and a minimum number of plates.

### STATEMENT OF INVENTION

We have now provided an improved static mixer for mixing a first fluid with a second fluid. The static mixer includes a series of plates having orifices through which the first and second fluids pass. As the first and second fluids pass through the static mixer, the fluids are mixed.

In one aspect, there is provided a static mixer comprising a body defining a chamber, the chamber having a longitudinal axis and a first axis perpendicular to the longitudinal axis, the chamber having a flow pathway for mixing a first fluid and a second fluid; a first plate positioned in the chamber and having an elongate orifice, having a length and a width, formed therethrough; a second plate positioned in the chamber and spaced along the longitudinal axis from the first plate, the second plate having a first orifice and a second orifice formed therethrough, wherein the first orifice is offset by an angle α relative to the first axis, and wherein the second orifice is offset by an angle α′ relative to the first axis.

In another aspect, there is provided a static mixer comprising a body defining a chamber, the chamber having a longitudinal axis, the chamber having a flow pathway for mixing a first fluid and a second fluid; a first plate positioned in the chamber and an orifice formed therethrough; a second plate positioned in the chamber and spaced along the longitudinal axis from the first plate, the second plate having an orifice formed therethrough, the orifice of the second plate being offset relative to the orifice of the first plate, wherein, as viewed along the longitudinal axis, a projection of the orifice of the first plate onto the second plate does not substantially intersect the orifice of the second plate.

### DESCRIPTION OF THE FIGURES

FIG. 1 is a perspective view of a static mixer positioned downstream from a T-junction;

FIG. 2 is a close-up perspective view of a static mixer of FIG. 1;

FIG. 3 is an end view of the first plate of a static mixer;

FIG. 4 is an end view of the second plate of a static mixer;

FIG. 5 is an end view of the third plate of a static mixer;

FIG. 6 is an end view of the fourth plate of a static mixer;

FIG. 7 is an end view of the first through fourth plates of a static mixer;

FIG. 8 is a perspective view of a static mixer illustrating a fluid pathway therethrough;

FIG. 9 is a perspective view of a static mixer including four plates having half-moon-shaped orifices;

FIG. 10 is a perspective view of a static mixer including four plates having pie shaped orifices;

FIG. 11 is a perspective view of a static mixer including four plates having H&I shaped orifices;

FIG. 12 is a perspective view of a static mixer including four plates having tab-shaped orifices; and

FIG. 13 is a perspective view of a static mixer including an additional configuration of the four plates having tab-shaped orifices of FIG. 12.

### DETAILED DESCRIPTION

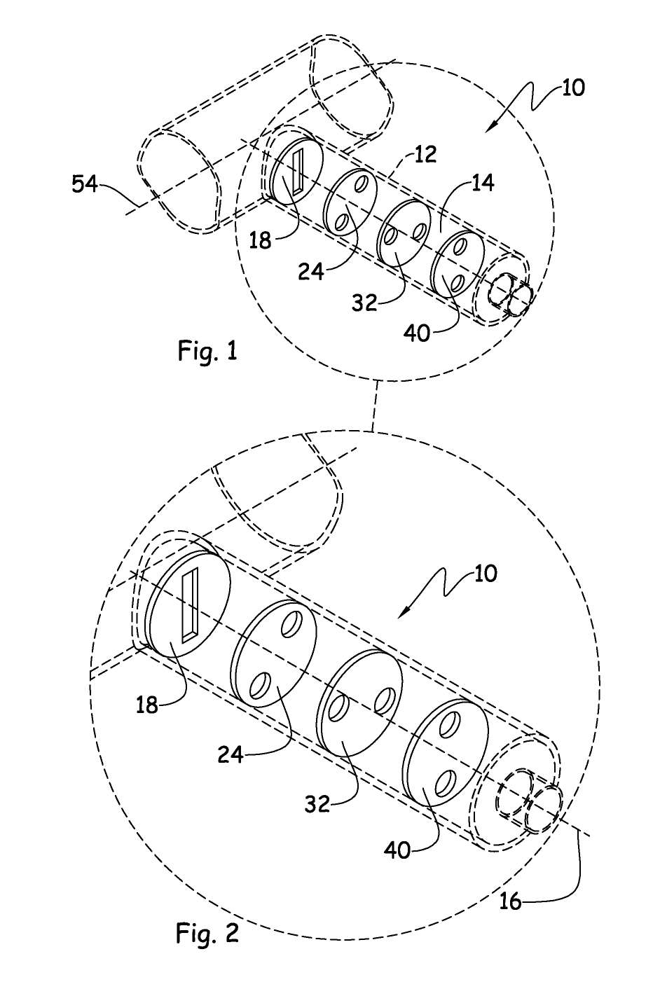

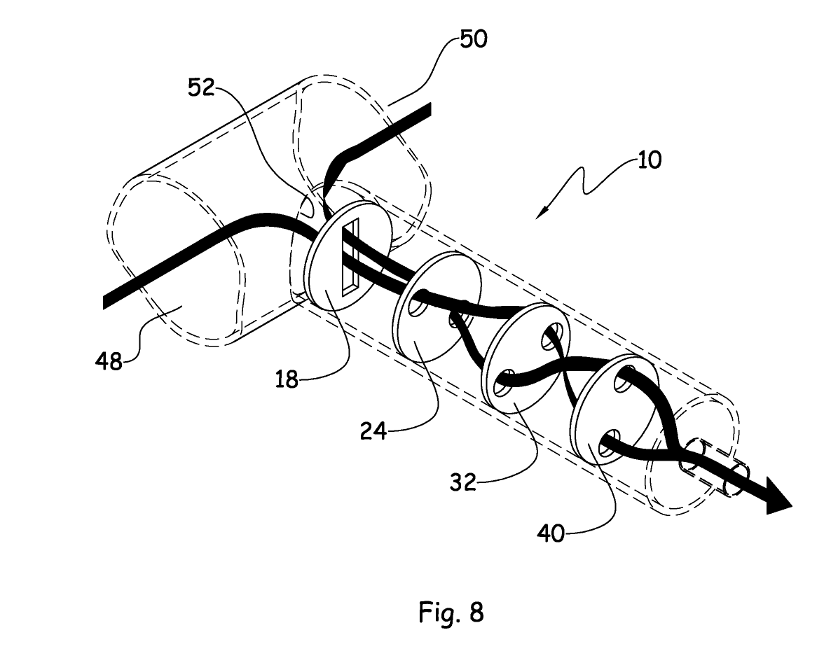

As noted above, this disclosure describes a static mixer 10 for mixing at least a first fluid and a second fluid. The static mixer 10 includes a body 12 which defines a chamber 14, as shown in FIGS. 1 and 2. The static mixer 10 can be used in combination with a T-junction, as shown in FIG. 8. The T-junction includes a first inlet 48, a second inlet 50 and an outlet 52. Preferably, the first inlet 48 and the second inlet 50 are parallel to an inlet axis 54. The static mixer 10 is positioned downstream from the outlet 52 of the T-junction. The first fluid passes through the first inlet 48, the second fluid passes through the second inlet 50. The first fluid and the second fluid pass through the outlet 52 and enter the static mixer 10.

In one aspect, the body 12 of the static mixer 10 comprises a section of pipe, where the wall of the pipe defines the chamber 14. The chamber 14 is a space within the body through which fluid is passable. The chamber 14 includes a longitudinal axis 16, which axis 16 is oriented along the length of the chamber. The chamber defines a fluid pathway through which at least a first fluid and a second fluid are mixed together. As is described in greater detail herein, one or more mixing plate is positioned in the chamber, with each plate including one or more orifice, which orifice also defines a portion of the fluid pathway. Preferably, the longitudinal axis 16 is oriented perpendicularly to the inlet axis 54.

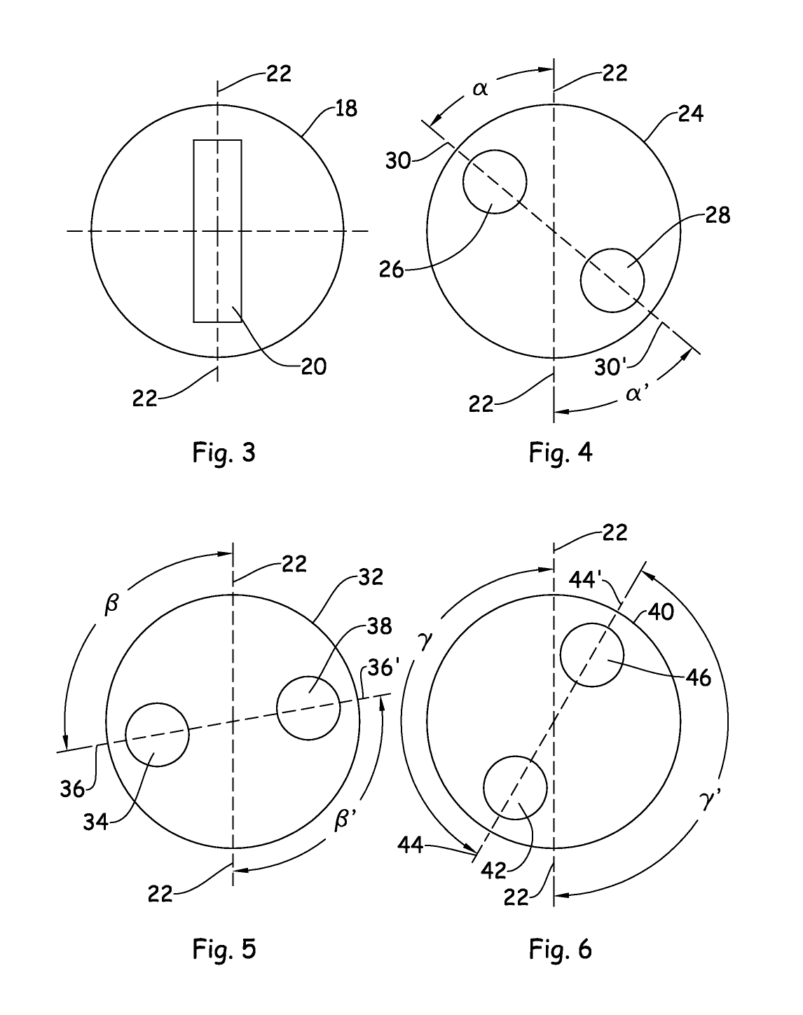

As noted above, the static mixer 10 includes a first plate 18, as shown in FIG. 3. The first plate 18 is positioned within the chamber 14 in the fluid pathway. The first plate 18 includes an elongate orifice 20 formed therethrough. The elongate orifice 20 defines an opening which serves as a portion of the fluid pathway. In one instance, the elongate orifice 20 is generally rectangular having a length and a width. The length of the elongate orifice 20 may be oriented generally parallel to a first axis 22. The first axis 22 is preferably perpendicular to the longitudinal axis 16. The first axis 22 is preferably perpendicular to the inlet axis 54. Preferably, each of the first axis 22, the longitudinal axis 16 and the inlet axis 54 are mutually orthogonal, wherein each axis is perpendicular to the other two axes. The width of the elongate orifice 20 may be oriented generally parallel to a second axis 56. Preferably, the elongate orifice 20 is centered on the first plate 18. In one instance, the elongate orifice 20 is from 10 to 30 percent of the area of the first plate 18. In another instance, the elongate orifice 20 is from 15 to 25 percent of the area of the first plate 18. Preferably the elongate orifice 20 is 20 percent of the area of the first plate 18. In one instance, the elongate orifice 20 is offset from the center of the first plate 18. In one instance, the elongate orifice 20 is rectangular with sharp corners. In another instance, the elongate orifice 20 has rounded corners. Preferably, the elongate orifice 20 is a shape which has a longer length than width. The elongate orifice 20 is illustrated as a rectangle, but it is understood that other shapes having a longer length than width are suitable, for example, an oval. In one instance, the elongate orifice 20 is the only opening in the first plate 18. In another instance, the first plate 18 includes at least one orifice in addition to the elongate orifice 20.

Without being limited by theory, it is expected that the elongate orifice 20 brings the first fluid and the second fluid into close contact and encourages mixing. With the long dimension (the length) of the elongate orifice 20 oriented perpendicularly to both the first inlet 48 and the second inlet 50, both streams are brought into close contact as the streams pass through the narrow width of the elongate orifice 20.

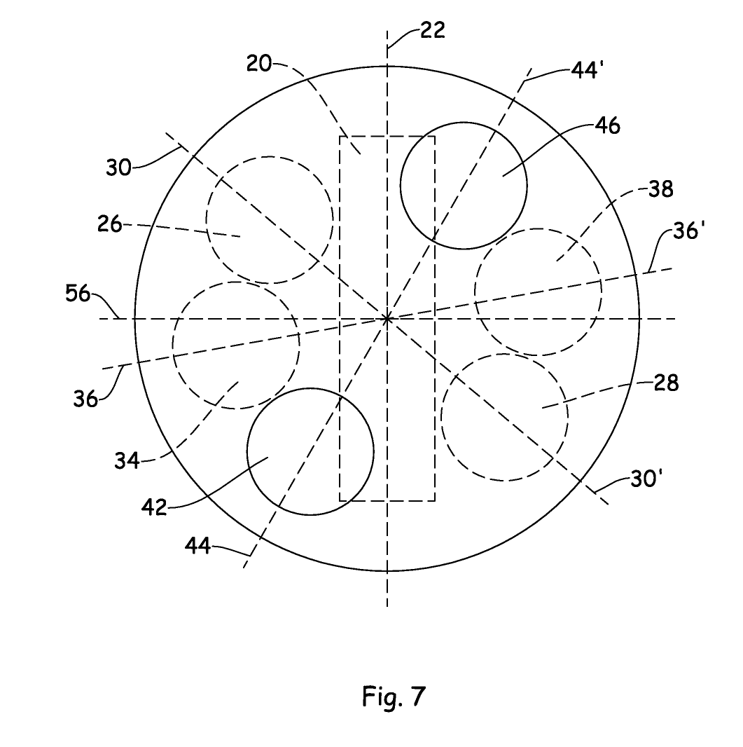

A second plate 24 is positioned within the chamber 14 in the fluid pathway. The second plate 24 is spaced along the longitudinal axis 16 from the first plate 18. As used herein, the term “spaced along” means a given plate is offset along the longitudinal axis 16 relative a reference plate, for example, referring to FIG. 1, each of the plates 24, 32 and 40 are spaced along the longitudinal axis 16 relative the first plate 18. In one instance, the second plate 24 is spaced downstream from the first plate 18. The second plate 24 includes a first orifice 26 formed therethrough. The first orifice 26 defines a portion of the fluid pathway. In one instance, the first orifice 26 is generally circular. A line 30 passing through the center of the second plate 24 and through the center of the first orifice 26 is offset by an angle α relative to the first axis 22. As used herein, “offset by an angle” refers to the position of a given orifice on a given plate relative a reference axis. In one instance, the angle α is from 10 to 90 degrees. Preferably, the angle α is from 40 to 60 degrees. In one instance, the first orifice 26 is spaced radially outwardly from the center of the second plate 24. In one instance, the first orifice 26 is offset relative to the elongate orifice 20 of the first plate 18, as shown in FIG. 7. As used herein, the orifice of a given plate is “offset relative” the orifice of an other plate when, as viewed along the longitudinal axis 16, the projection of the orifice of the given plate onto the other plate does not intersect the orifice of the other plate. In one instance, “offset relative” means that no part of the projection of the orifice of the given plate intersects the orifice of the other plate. In another instance, “offset relative” means that the projection of the orifice of the given plate does not substantially intersect the orifice of the other plate. In one instance, substantially intersect means that the given orifices intersect by 50% or less. In another instance, substantially intersect means the given orifices intersect by less than 30%. In yet another instance, substantially intersect means that the given orifices intersect by less than 10%. In one instance, the first orifice 26 is from 3 to 30 percent of the area of the second plate 24. In one instance, the first orifice 26 is from 5 to 15 percent of the area of the second plate 24. In one instance the first orifice 26 is 10 percent of the area of the second plate 24.

In one instance, the second plate 24 includes a second orifice 28 formed therethrough. The second orifice 28 defines a portion of the fluid pathway. In one instance, the second orifice 28 is generally circular. A line 30′ passing through the center of the second plate 24 and through the center of the second orifice 28 is offset by an angle α′ relative to the first axis 22. In one instance, the angle α′ is from 10 to 90 degrees. Preferably, the angle α′ is from 40 to 60 degrees. In one instance, the second orifice 28 is spaced radially outwardly from the center of the second plate 24. In one instance, the line 30 and the line 30′ both overlie a common diameter of the second plate 24, such that the angle α is equivalent to the angle α′. In another instance, the first orifice 26 and the second orifice 28 are not aligned along a common diameter of the second plate 24, and the angle α is different than the angle α′. In one instance, the second orifice 28 is offset relative to the elongate orifice 20 of the first plate 18, as illustrated in FIG. 7. In one instance, the second orifice 28 is from 3 to 30 percent of the area of the second plate 24. In one instance, the second orifice 28 is from 5 to 15 percent of the area of the second plate 24. In one instance, the second orifice 28 is 10 percent of the area of the second plate 24.

In one instance, the combined area of the first orifice 26 of the second plate 24 and the second orifice 28 of the second plate 24 is from 10 to 30 percent of the area of the second plate 24. In one instance, the combined area of the first orifice 26 and the second orifice 28 is from 15 to 25 percent of the area of the second plate 24. In one instance, the combined area of the first orifice 26 and the second orifice 28 is 20 percent of the area of the second plate 24.

A third plate 32 is positioned within the chamber 14 in the fluid pathway. The third plate 32 is spaced along the longitudinal axis 16 from the second plate 24. In one instance, the third plate 32 is spaced downstream from the second plate 24. The third plate 32 includes a first orifice 34 formed therethrough. The first orifice 34 defines a portion of the fluid pathway. In one instance, the first orifice 34 is generally circular. A line 36 passing through the center of the third plate 32 and through the center of the first orifice 34 is offset by an angle β relative to the first axis 22. In one instance, the angle β is from 20 to 180 degrees. In one instance, the angle β is from 80 to 180 degrees. In one instance, the first orifice 34 is spaced radially outwardly from the center of the third plate 32. In one instance, the first orifice 34 is offset relative to the first orifice 26 and the second orifice 28 of the second plate 24, as illustrated in FIG. 7. In one instance, the first orifice 34 is from 3 to 30 percent of the area of the third plate 32. In one instance, the first orifice 34 is from 5 to 15 percent of the area of the third plate 32. In one instance, the first orifice 34 is 10 percent of the area of the third plate 32.

In one instance, the third plate 32 includes a second orifice 38 formed therethrough. The second orifice 38 defines a portion of the fluid pathway. In one instance, the second orifice 38 is generally circular. A line 36′ passing through the center of the third plate 32 and through the center of the second orifice 38 is offset by an angle β′ relative to the first axis 22. In one instance, the angle β′ is from 20 to 180 degrees. In one instance, the angle β′ is from 80 to 180 degrees. In one instance, the second orifice 38 is spaced radially outwardly from the center of the third plate 32. In one instance, the line 36 and the line 36′ both overlie a common diameter of the third plate 32, such that the angle β is equivalent to the angle β′. In another instance, the first orifice 34 and the second orifice 38 are not aligned along a common diameter of the third plate 32, and the angle β is different than the angle β′. In one instance, the second orifice 38 is offset relative to the first orifice 26 and the second orifice 28 of the second plate 24, as illustrated in FIG. 7. In one instance, the second orifice 38 is from 3 to 30 percent of the area of the third plate 32. In one instance, the second orifice 38 is from 5 to 15 percent of the area of the third plate 32. In one instance, the second orifice 38 is 10 percent of the area of the third plate 32.

In one instance, the combined area of the first orifice 34 of the third plate 32 and the second orifice 38 of the third plate is from 10 to 30 percent of the area of the third plate 32. In one instance, the combined area of the first orifice 34 and the second orifice 38 is from 15 to 25 percent of the area of the third plate 32. In one instance, the combined area of the first orifice 34 and the second orifice 38 is 20 percent of the area of the third plate 32.

A fourth plate 40 is positioned within the chamber 14 in the fluid pathway. The fourth plate 40 is spaced along the longitudinal axis 16 from the third plate 32. In one instance, the fourth plate 40 is spaced downstream from the third plate 32. The fourth plate 40 includes a first orifice 42 formed therethrough. The first orifice 42 defines a portion of the fluid pathway. In one instance, the first orifice 42 is generally circular. A line 44 passing through the center of the fourth plate 40 and through the center of the first orifice 42 is offset by an angle γ relative to the first axis 22. In one instance, the angle γ is from 30 to 270 degrees. In one instance, the angle γ is from 120 to 180 degrees. In one instance, the first orifice 42 is spaced radially outwardly from the center of the fourth plate 40. In one instance, the first orifice 42 is offset relative to the first orifice 34 and the second orifice 38 of the third plate 32, as illustrated in FIG. 7. In one instance, the first orifice 42 is from 3 to 30 percent of the area of the fourth plate 40. In one instance, the first orifice 42 is from 5 to 15 percent of the area of the fourth plate 40. In one instance, the first orifice 42 is 10 percent of the area of the fourth plate 40.

In one instance, the fourth plate 40 includes a second orifice 46 formed therethrough. The second orifice 46 defines a portion of the fluid pathway. In one instance, the second orifice 46 is generally circular. A line 44′ passing through the center of the fourth plate 40 and through the center of the second orifice 46 is offset by an angle γ′ relative to the first axis 22. In one instance, the angle γ is from 30 to 270 degrees. In one instance, the angle γ is from 120 to 180 degrees. In one instance, the second orifice 46 is spaced radially outwardly from the center of the fourth plate 40. In one instance, the line 44 and the line 44′ both overlie a common diameter of the fourth plate 40, such that the angle γ is equivalent to the angle γ′. In another instance, the first orifice 42 and the second orifice 46 are not aligned along a common diameter of the fourth plate 40, and the angle γ is different than the angle γ′. In one instance, the second orifice 46 is offset relative to the first orifice 34 and the second orifice 38 of the third plate 32, as illustrated in FIG. 7. In one instance, the second orifice 46 is from 3 to 30 percent of the area of the fourth plate 40. In one instance, the second orifice 46 is from 5 to 15 percent of the area of the fourth plate 40. In one instance, the second orifice 46 is 10 percent of the area of the fourth plate 40.

In one instance, the combined area of the first orifice 42 of the fourth plate 40 and the second orifice 46 of the fourth plate 40 is from 10 to 30 percent of the area of the fourth plate 40. In one instance, the combined area of the first orifice 42 and the second orifice 46 is from 15 to 25 percent of the area of the fourth plate 40. In one instance, the combined area of the first orifice 42 and the second orifice 46 is 20 percent of the area of the fourth plate 40.

In one instance the static mixer 10 only includes the first plate 18 and the second plate 24. In one instance, the static mixer includes three or more plates. In one instance, the static mixer 10 includes four or more plates. The plates included in the static mixer 10 are collectively referred to as the mixing plates.

In one instance, the fluid pathway is defined by a first helix-like fluid pathway and a second helix-like fluid pathway. One representative embodiment of the first and second helix-like fluid pathways is provided in FIG. 8. It is understood that the fluid will intermix between each plate, and that it is unlikely that the bulk of the fluid will follow either the first or second helix-like fluid pathways through the length of the static mixer 10. For this reason, the fluid pathways shown in FIG. 8 do not represent the unmixed incoming streams, but instead illustrate two possible helix-like pathways through the mixing plates. The two helix-like pathways are shown converging to a single pathway as they exit the static mixer 10. Without being limited by theory, it is expected that the first and second helix-like pathways help explain how the present system accomplishes a good COV while minimizing pressure drop. It is expected that as the fluid moves through the mixing plates, the fluid will be encouraged into a pair of helix-like flow paths which will encourage mixing while minimizing pressure drop. It is expected that ensuring that the orifices of successive plates are offset relative to each other encourages these helix-like pathways. It is expected that having α, β and γ in the ranges specified herein encourages these helix-like pathways.

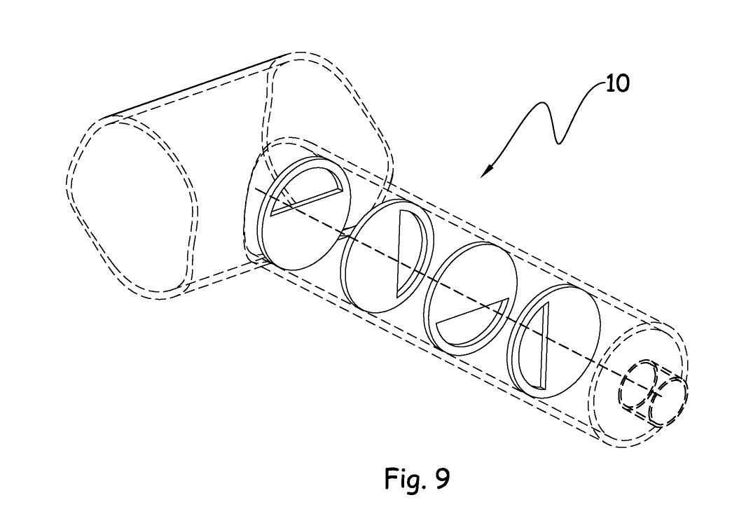

In some instances, the orifices are not shaped as rectangles or circles. FIGS. 9-13 provide examples of variations in orifice shape. In each of these Figures, a static mixer 10 is shown having mixing plates with orifices of various shapes.

FIG. 9 shows plates having half-moon-shaped orifices. The half-moon-shaped orifices are shaped as a segment of a circle. In one instance, the half-moon shaped orifices are shaped as a segment of a circle defined by a chord of the circle. In one instance, the position of the half-moon-shaped orifices is rotated on each successive plate to encourage a helix-like flow pathway through the static mixer 10. In one instance, the position of the half-moon-shaped orifices is rotated from 45 to 135 degrees on each successive plate. In another instance, the position of the half-moon-shaped orifices is rotated 90 degrees on each successive plate, as illustrated in FIG. 9.

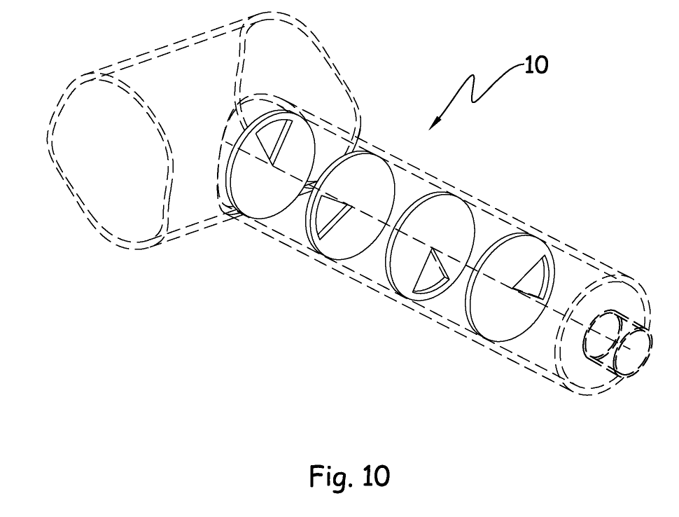

FIG. 10 shows plates having pie-shaped orifices. The pie-shaped orifices are wedge-shaped, for example, a quarter circle. In one instance, the position of the pie-shaped orifices is rotated on each successive plate to encourage a helix-like flow pathway through the static mixer 10. In one instance, the position of the pie-shaped orifices is rotated from 45 to 135 degrees on each successive plate. In another instance, the position of the pie-shaped orifices is rotated 90 degrees on each successive plate, as illustrated in FIG. 10.

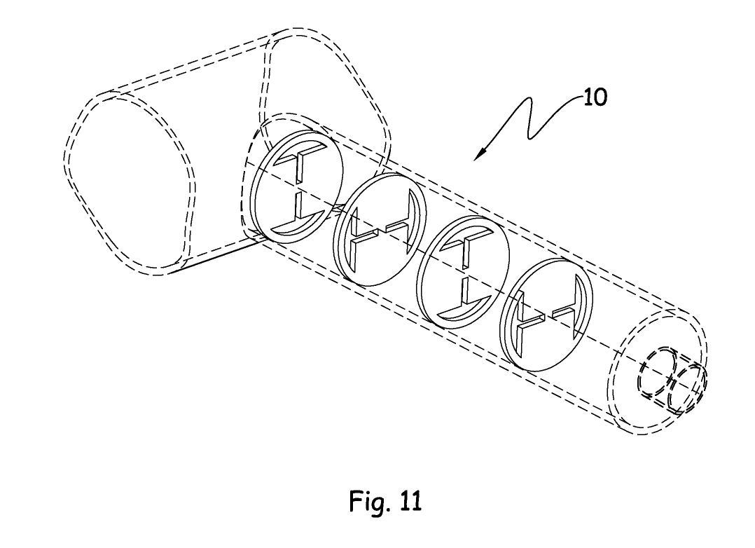

FIG. 11 shows plates having H&I-shaped orifices. The H&I-shaped orifices are a variation of the half-moon-shaped orifices which include a member extending toward the center of the plate. In one instance, the position of the H&I-shaped orifices is rotated on each successive plate to encourage a pair of helix-like flow pathways through the static mixer 10. In one instance, the position of the H&I-shaped orifices is rotated from 45 to 135 degrees on each successive plate. In another instance, the position of the H&I-shaped orifices is rotated 90 degrees on each successive plate, as illustrated in FIG. 11.

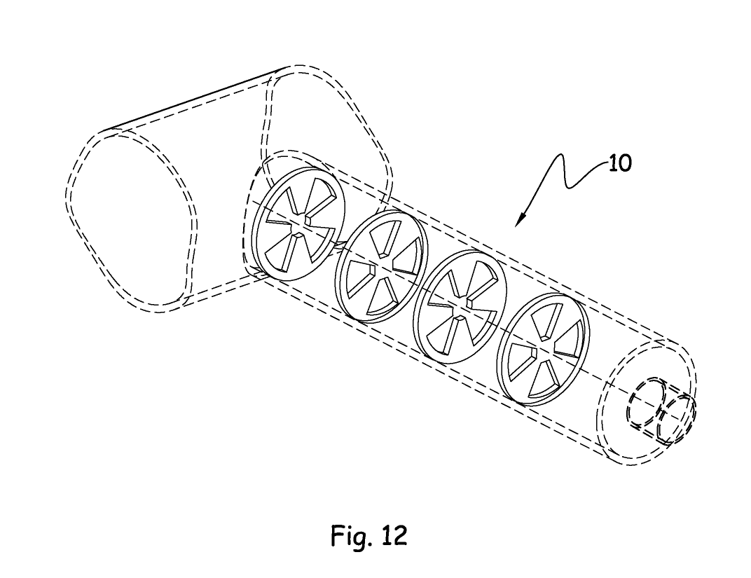

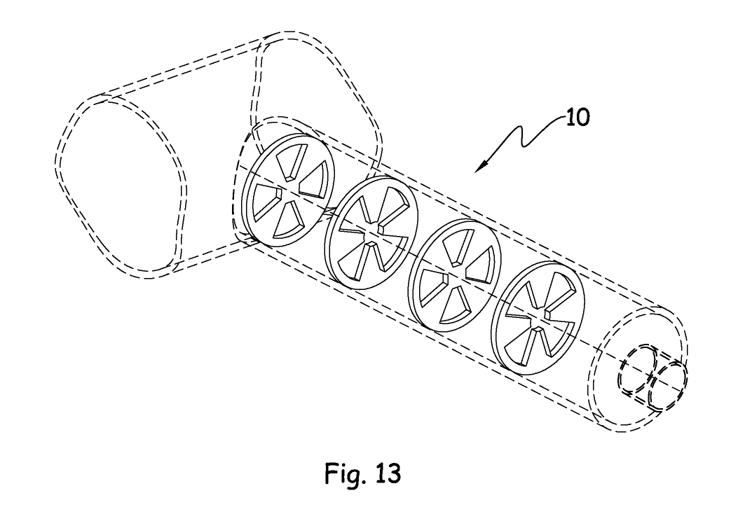

FIGS. 12 and 13 show plates having tab-shaped orifices. In one instance, the tab-shaped orifices are connected to each other at the center of the plate. In another instance, the tab-shaped orifices are not connected with each other at the center of the plate. In one instance, the position of the tab-shaped orifices is rotated on each successive plate to encourage a plurality of helix-like flow pathways through the static mixer 10. In another instance, the first and third plates include tab-shaped orifices which are connected to each other at the center of the plate and the second and fourth plates include tab-shaped orifices which are not connected to each other at the center of the plate, as illustrated in FIG. 12. In another instance, the first and third plates include tab-shaped orifices which are not connected to each other at the center of the plate and the second and fourth plates include tab-shaped orifices which are connected to each other at the center of the plate, as illustrated in FIG. 13.

In each of the embodiments shown in FIGS. 9-11, the combined area of the orifice(s) on a given plate is from 10 to 30 percent of the area of that plate. In one instance, the combined area of the orifice(s) on a given plate is from 15 to 25 percent of the area of that plate. In one instance, the combined area of the orifice(s) on a given plate is 20 percent of the area of that plate. In the several variations shown in FIGS. 10-13, the orientation of the successive plates will preferably be such that an orifice of a given plate does not intersect the orifice of an adjacent plate, as viewed on-end. It is expected that one or more mixing plates may be mixed and matched among the several variations shown and described herein.

As used herein, “successive plate” refers to the plate preceding or the plate following a given plate in the flow pathway. In one instance, each orifice on a given plate is offset relative to each orifice on a successive plate. In one instance, the orifice offset on successive plates encourages the fluid pathway to have a helix-like flow shape.

In one instance, the static mixer 10 is used to mix two flows which have similar characteristics. Preferably, the two flows are miscible, single phase, and have generally the same mass flow rate. In one instance, one of the flows has a higher density than the other of the flows. For example, when the static mixer 10 is used in combination with a reactor vessel, one flow may be a heavy fluid having a high density and viscosity as compared to the other flow which may be a light fluid having a low density and viscosity. Without being limited by theory, it is expected that the static mixer 10 described herein causes the heavy fluid and the light fluid to impinge upon each other and then to mix in a helix-like fashion and that the geometry of the present static mixer 10 improves mixing and eliminates stratification of the mixed fluid.

In one instance, an apparatus is provided comprising the static mixer as described herein used in combination with a T-junction, the T-junction having a first inlet, a second inlet, and an outlet, wherein the static mixer is positioned downstream from the outlet, the first inlet and the second inlet are both oriented perpendicularly relative to the first axis.

The above description is illustrated by the following examples. These examples are illustrative and are not to be read as limiting the scope of the present invention.

### EXAMPLES

Computational Design

The static mixer 10, including plates, and the T-junction shown in FIG. 8 are modeled in SolidWorks software produced by Dassault Systèmes SolidWorks Corp. The T-junction is modeled as having a first inlet 48 having a 19.67 cm inner diameter and a second inlet 50 having a 19.67 cm inner diameter. The body 12 of the static mixer 10 is modeled as having a 19.67 cm inner diameter. The distance from the center of first inlet 48 and the second inlet 50 to the end of the static mixer 10 is 40.64 cm in length as measured along the longitudinal axis 16. The static mixer 10 is modeled as having an outlet which is in fluid communication with an outlet pipe having a 9.72 cm inner diameter. The mixing plates are each spaced 7.62 cm apart. The models are transferred to Ansys Workbench 14.5 software produced by Ansys, Inc. to transform the SolidWorks models into a polygon mesh. The pipe sections are meshed using hex cell elements. The T-junction and the mixing plates are meshed with tetrahedral cell elements. Mixing simulations are conducted on these meshed elements using Ansys Fluent 14.5 software produced by Ansys, Inc. using the standard k-epsilon turbulence model. The two incoming fluids are modeled as two miscible components of a single phase flow, and the species transport model is used to evaluate the mixing performance.

The static mixer 10 is modeled as mixing a first fluid, “Heavy Fluid” and a second fluid, “Light Fluid.” The characteristics of the first and second fluids are summarized in Table 1. The characteristics of the mixed fluid are also summarized in Table 1.

TABLE 1

| | Heavy Fluid | Light Fluid | Mixed Fluid | Units |
|---|---|---|---|---|
| Mass Flow Rate | 34019 | 28758 | 62777 | kg/hr |
| Density | 1441 | 949.1 | 1216 | kg/m³ |
| Viscosity | 25.0 | 1.3 | 14.1 | mPa * s |
| Volumetric Flow | 23.6 | 30.3 | 51.6 | m³/hr |
| Velocity | 0.22 | 0.29 | 1.93 | m/s |
| Reynolds number | 2485 | 40397 | 16154 | |
| Velocity Head | 0.24 | 0.43 | 19.1 | cm |

Experimental Results

Table 2 provides data related to a series of experiments using the Computational Design. Slot-width refers to the width of the elongate opening 20 of the first plate 18. In each case, the length of the elongate opening 20 is set at 16.51 cm. Slot-angle refers to the angular orientation of the elongate opening 20 as compared to the first axis 22. The first axis 22 is perpendicular to the inlet axis 54. α refers to the degrees of rotation of the line 30 relative to the first axis 22 (unless otherwise indicated, the experimental design assumes α and α′ are equal and that 30 overlies 30′). β refers to the degrees of rotation of the line 36 relative to the first axis 22 (unless otherwise indicated, the experimental design assumes β and β′ are equal and that 36 overlies 36′). γ refers to the degrees of rotation of the line 44 relative to the first axis 22 (unless otherwise indicated, the experimental design assumes γ and γ′ are equal and that 44 overlies 44′). COV refers to the calculated COV based on the values listed for the several variables. COV is measured at a cross-section spaced 41.91 cm from the inlet axis 54 which is a centerline passing through the first inlet 48 and the second inlet 50, such that the COV is measured in the outlet pipe. dp refers to the pressure drop, as measured in kilopascals (kPa). dp is measured at the same cross-section as COV. COV and dp are calculated using the Computational Design. A value of “-” means that in that Case the given plate is not included in the experimental design. For example, in Case 2, the model is run with only plates 1 and 2 (plates 3 and 4 are excluded).

TABLE 2

| | Design Parameters | | | | | | |
|---|---|---|---|---|---|---|---|
| | Slot- | Slot- | | | | | |
| | width | angle | | | γ | Results | |
| | (cm) | (deg) | α (deg) | β (deg) | (deg) | COV | dp (kPa) |
| Case 1 | 3.6 | 0 | 60 | 120 | 180 | 0.0036 | 29.4 |
| Case 2 | 3.6 | 10 | 60 | — | — | 0.0013 | 29.2 |
| Case 3 | 3.6 | −10 | 60 | — | — | 0.0061 | 30.1 |
| Case 4 | 3.6 | 0 | 50 | — | — | 0.0044 | 30.0 |
| Case 5 | 3.6 | 0 | 50 | 130 | — | 0.0050 | 30.3 |
| Case 6 | 3.6 | 0 | 70 | 110 | — | 0.0083 | 28.6 |
| Case 7 | 3.6 | 0 | 60 | 110 | 160 | 0.0037 | 28.3 |
| Case 8 | 3.6 | 0 | 90 | 150 | 210 | 0.0148 | 31.4 |
| Case 9 | 3.6 | 0 | 50 | 110 | 170 | 0.0046 | 28.2 |
| Case 10 | 3.6 | 20 | 60 | — | — | 0.0024 | 28.5 |
| Case 11 | 3.6 | 90 | 60 | — | — | 0.0240 | 29.8 |
| Case 12 | 3.6 | 0 | 20 | — | — | 0.0111 | 32.8 |
| Case 13 | 3.6 | 0 | 0 | — | — | 0.0356 | 27.6 |
| Case 14 | 3.8 | 0 | 60 | — | — | 0.0042 | 28.1 |
| Case 15 | 4.1 | 0 | 60 | — | — | 0.0046 | 27.3 |

Case 1 is also run using flow rates which are 75% and 125% of the values listed in Table 1. In each case, the COV is 0.004. For the 75% case, the pressure drop is 15.2 kPa. For the 125% case, the pressure drop is 47.6 kPa.

Table 3 provides data related to instances where the plates have orifices which are shaped other than elongate slots or circles. Case 21 provides the instance where no plates are included in the mixer.

TABLE 3

| | |
|---|---|
| Design Parameters | Results |

| | Orifice Geometry | COV | dp (kPa) |
|---|---|---|---|
| Case 16 | Half-moon (see | 0.015 | 29.2 |
| | FIG. 9) | | |
| Case 17 | Pie (see FIG. 10) | 0.011 | 40.1 |
| Case 18 | H&I (see FIG. 11) | 0.096 | 29.8 |
| Case 19 | Tabs (see FIG. 12) | 0.253 | 13.8 |
| Case 20 | Tabs (see FIG. 13) | 0.237 | 13.8 |
| Case 21 | No plates | 0.349 | 0.1 |

1. A static mixer comprising:
a body defining a chamber, the chamber having a longitudinal axis and a first axis perpendicular to the longitudinal axis, the chamber having a flow pathway for mixing a first fluid and a second fluid;
a first plate positioned in the chamber and having an elongate orifice, having a length and a width, formed therethrough;
a second plate positioned in the chamber and spaced along the longitudinal axis from the first plate, the second plate having a first orifice and a second orifice formed therethrough, wherein the first orifice is offset by an angle α relative to the first axis, and wherein the second orifice is offset by an angle α′ relative to the first axis,
wherein α and α′ are each independently from 10 to 90 degrees;
a third plate positioned in the chamber and spaced along the longitudinal axis from the second plate, the third plate having a first orifice and a second orifice formed therethrough, wherein the first orifice is offset by an angle β relative to the first axis, and wherein the second orifice is offset by an angle β′ relative to the first axis, wherein β and β′ are each independently from 20 to 180 degrees; and
wherein each orifice on a given plate is offset relative to each orifice on a successive plate, wherein when viewed along the longitudinal axis, no part of a projection of any orifice of a given plate onto a successive plate intersects any portion of any orifice on the successive plate.

2. The static mixer of claim 1, wherein α and α′ are each independently from 40 to 60 degrees.

3. The static mixer of claim 1, wherein β and β′ are each independently from 80 to 180 degrees.

4. The static mixer of claim 1, further comprising a fourth plate positioned in the chamber and spaced along the longitudinal axis from the third plate, the fourth plate having a first orifice and a second orifice formed therethrough, wherein the first orifice is offset by an angle γ relative to the first axis, and wherein the second orifice is offset by an angle γ′ relative to the first axis, wherein γ and γ′ are each independently from 30 to 270 degrees.

5. The static mixer of claim 4, wherein γ and γ′ are each independently from 120 to 180 degrees.

6. The static mixer of claim 4, wherein a first helix-like fluid pathway is defined by the first orifice of the second plate, the first orifice of the third plate, and the first orifice of the fourth plate, and a second helix-like fluid pathway is defined by the second orifice of the second plate, the second orifice of the third plate, and the second orifice of the fourth plate.

7. The static mixer of claim 1, wherein the length of the elongate orifice of the first plate is parallel to the first axis.

8. An apparatus comprising the static mixer of any one of claims 1 used in combination with a T-junction, the T-junction having a first inlet, a second inlet, and an outlet, wherein the static mixer is positioned downstream from the outlet, the first inlet and the second inlet are both oriented perpendicularly relative to the first axis.

9. A static mixer comprising:
a body defining a chamber, the chamber having a longitudinal axis, the chamber having a flow pathway for mixing a first fluid and a second fluid;
a first plate positioned in the chamber and an orifice formed therethrough;
a second plate positioned in the chamber and spaced along the longitudinal axis from the first plate, the second plate having an orifice formed therethrough, the orifice of the second plate being offset relative to the orifice of the first plate, wherein, as viewed along the longitudinal axis, a projection of the orifice of the first plate onto the second plate does not substantially intersect the orifice of the second plate.

10. The static mixer of claim 9, wherein the orifice of the first plate is the only orifice formed through the first plate, the orifice of the second plate is the only orifice formed through the second plate, the orifice of the first plate is either half-moon-shaped or pie-shaped and the orifice of the second plate is either half-moon-shaped or pie-shaped.
